(19) United States
(12) Patent Application Publication
(10) Pub. No.: US 2005/0077229 A1
(43) Pub. Date: Apr. 14, 2005

(54) Spiral membrane element and method of manufacturing the same

(75) Inventor: Katsumi Ishii, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/954,211

(22) Filed: Oct. 1, 2004

(30) Foreign Application Priority Data
Oct. 2, 2003 (JP) P. 2003-344303

(51) Int. Cl. B01D 63/00

(52) U.S. Cl. 210/321.83; 210/321.85; 55/520; 96/4

(57) ABSTRACT

A spiral membrane element having an enlarged effective membrane surface area without having its separation performance lowered, while maintaining the sealing property of any sealing portion of a cylindrically wound body, and a manufacturing method of the same are disclosed. The spiral membrane element includes a cylindrically wound body comprising a perforated central tube and, spirally wound therearound, a separation membrane, a feed-side passage material and a permeation-side passage material in a laminated state, and a sealing portion for preventing a feed-side fluid and a permeation-side fluid from being mixed together, wherein the sealing portion formed at each of both ends of the cylindrically wound body is spirally formed with a substantially constant width by an adhesive and has a trimmed section formed on its whole end surface, and the cylindrically wound body has a ratio of its length to the length of the central tube of 0.96 to 1.00, and a ratio of an ineffective membrane surface area to the entire membrane surface area of 0.02 to 0.10.

### FIELD OF THE INVENTION

This invention relates to a spiral membrane element comprising a cylindrically wound body comprising a perforated central tube and, spirally wound therearound, a separation membrane, a feed-side passage material and a permeation-side passage material in a laminated state, and a sealing portion for preventing a feed-side fluid and a permeation-side fluid from being mixed together.

### BACKGROUND ART

As a fluid separation element used in reverse osmosis, ultrafiltration, microfiltration, gas permeation, degassing, etc., there is known, for example, a spiral fluid separation element comprising a central tube and, spirally wound therearound, a unit comprising a feed-side passage material guiding a feed-side fluid to the surface of a separation membrane, the separation membrane separating the feed-side fluid, and a permeation-side passage material guiding to the central tube a permeation-side fluid separated from the feed-side fluid by permeating through the separation membrane.

Such a spiral membrane element is usually manufactured by alternately layering a feed-side passage material held between two halves of a folded separation membrane and a permeation-side passage material, applying an adhesive to the edges of the separation membrane (along three sides thereof) to prevent any mixing of a feed fluid and a permeation-side fluid to prepare a separation membrane unit, winding one or more such units spirally around a central tube to form a cylindrically wound body, and trimming both ends of the body (modifying those ends). The spiral membrane element thus manufactured has a structure such that the separation membrane, feed-side passage material and permeation-side passage material are spirally wound in a laminate state around a perforated central tube and a sealing portion for preventing the feed-side fluid and the permeation-side fluid from being mixed together is provided.

In such a spiral membrane element, the feed-side passage material has two principal functions, (1) securing a feed-side passage and (2) stirring the feed-side fluid to prevent concentration polarization in the vicinity of the separation membrane. When the function (2) is exhibited, a pressure loss occurs to the feed fluid passage.

In order to reduce any pressure loss occurring to the feed-side passage in the separation membrane element, a method is known which alters the pitch or angle of the meshes in the feed-side passage material, or increases the thickness of the feed-side passage material (see, for example, Japanese Patent 3,230,490 and JP-A-11-235520).

The former method, however, makes the feed-side passage material less effective for stirring the feed-side fluid to prevent concentration polarization in the vicinity of the separation membrane and lowers the separation performance of the spiral membrane element. The latter method enables the spiral membrane element to be packed with only a smaller amount of separation membranes and lowers its permeation performance.

On the other hand, it has hitherto been usual to make a cylindrically wound body with an axial length as large as possible relative to that of a central tube, since a larger length of the cylindrically wound body (membrane portion) of a spiral membrane element is beneficial for enlarging the surface area of the membrane when the element is placed in a membrane module container.

The cylindrically wound body is, however, spirally sealed (such as adhesion) along a certain width toward both ends thereof, and unless each such sealing portion has at least a certain axial width, it has been impossible to make any reliable sealing and it has been impossible to keep any ineffective membrane surface area below a certain size even if the axial length of the cylindrically wound body may be close to the length of the central tube.

### SUMMARY OF THE INVENTION

Accordingly, one object of the present invention is to provide a spiral membrane element having an enlarged effective membrane surface area without having its separation performance lowered, while maintaining the sealing property of any sealing portion of a cylindrically wound body.

Another object of the present invention is to provide a method of manufacturing the spiral membrane element.

As a result of extensive investigations on methods and structures for sealing both ends of an element to achieve the above object, it has been found that it is possible to form a sealing portion having a small width, while maintaining the sealing property of both ends, by cutting and removing a part of any sealing portion after forming it instead of initially forming any sealing portion having a small width.

Thus, the spiral membrane element according to the present invention comprises a cylindrically wound body comprising a perforated central tube and, spirally wound therearound, a separation membrane, a feed-side passage material and a permeation-side passage material in a laminated state, and a sealing portion for preventing a feed-side fluid and a permeation-side fluid from being mixed together, wherein the sealing portion formed at each of both ends of the cylindrically wound body is spirally formed with a substantially constant width by an adhesive and has a trimmed section formed on its whole end surface, and the cylindrically wound body has a ratio of its length to the length of the central tube of 0.96 to 1.00, and a ratio of an ineffective membrane surface area to the entire membrane surface area of 0.02 to 0.10.

The spiral membrane element of the present invention has its sealing portions reduced in width, while maintaining their sealing property, and thereby has a lower ratio of ineffective membrane surface area, while maintaining at least a certain length for its cylindrically wound body, since each of the sealing portions formed at both ends of the cylindrically wound body has an outer part cut off and exposes a trimmed section on its whole end surface. It has an increased effective membrane surface area without having its stirring action lowered or having its separation performance lowered by any increase in thickness, since its feed-side passage material does not call for any change in particular. The effective membrane surface area is the whole membrane surface area other than the total membrane surface area of any and all ineffective portions failing to exhibit any separation performance despite the separation membrane, such as the sealing portions at both ends of the cylindrically wound body, any adhesive sealed portion formed by applying an adhesive to the edges of the separation membrane and any portion having a protective tape bonded to the fold of the separation membrane.

The reduction in width of the sealing portions also makes it possible to reduce any pressure loss per unit effective surface area of the spiral membrane element and suppress any increase in the cost of manufacture, since there is no increase of materials to be used, while also reducing any waste, since there is a decrease of the part removed by trimming.

The adhesive is preferably a thixotropic fluid. It is often unavoidable due to work arrangements that the adhesive applied to the edges of the separation membrane is left to stand for a certain period of time until the membrane, etc., are wound around the central tube, and on that occasion, any ordinary adhesive spreads by its own weight and forms a sealing portion having a large width. On the other hand, a thixotropic fluid, which has the property of becoming lower in viscosity when given an external force, easily remains in its state as applied if not given any external force after application, so that it facilitates the formation of a sealing portion having a controlled width.

The separation membrane bonded adhesively on the sealing portions at both ends preferably has the pores of its porous layer closed. The separation membrane usually has a porous structure and allows a fluid to flow in both directions perpendicular and parallel to the membrane. It is however only when the fluid flows in the direction perpendicular to the separation membrane that the membrane exhibits its separation performance. It is therefore necessary to suppress any fluid flow parallel to the separation membrane in the spiral membrane element. It is however sometimes impossible for any adhesive applied to the edges of the separation membrane to suppress any parallel fluid flow completely, and it is sometimes necessary to enlarge the width of each sealing portion, thereby increasing the length of any parallel fluid flow passage and creating a higher resistance to any parallel fluid flow, and as a result it suppresses flow in a parallel direction. Under these circumstances, the closure of the pores in the porous layer of each adhesive-coated portion of the separation membrane as stated above makes it possible to suppress any fluid flow parallel to the membrane and thereby reduce the width of each sealing portion.

The method of manufacturing a spiral membrane element according to the present invention comprises the steps of spirally winding a separation membrane, a feed-side passage material and a permeation-side passage material in a laminate state around a perforated central tube to form a cylindrically wound body, and forming a sealing portion for preventing a feed-side fluid and a permeation-side fluid from being mixed together, wherein the sealing portion is formed with a substantially constant width by an adhesive in the vicinity of each of both ends of the cylindrically wound body and has 20 to 60% of its width cut off.

The manufacturing method of the present invention makes it possible to obtain a spiral membrane element having a small width along each sealing portion, while maintaining its sealing property at both ends, and having a large effective membrane surface area without having its separation performance lowered, since it does not initially has any sealing portion having a small width, but a part of each sealing portion is cut off after sealing.

### BRIEF DESCRIPTION OF THE DRAWINGS

FIGS. 1A and 1B each are a step view illustrating a method of manufacturing a spiral membrane element according to the present invention.

FIG. 2 is another step view illustrating the method of manufacturing a spiral membrane element according to the present invention.

FIG. 3 is still another step view illustrating the method of manufacturing a spiral membrane element according to the present invention.

FIG. 4 is an exploded view of a spiral membrane element according to the present invention.
101: Separation membrane
102: Feed-side passage material
103: Permeation-side passage material
105: Central tube
300: Cylindrically wound body (before trimming)
302: Sealing portions (at both ends)
303: Sealing portions (at outer edges)
304: Cylindrically wound body (after trimming)
A: Length of central tube
B: Length of cylindrically wound body
U: Separation membrane unit

### DETAILED DESCRIPTION OF THE INVENTION

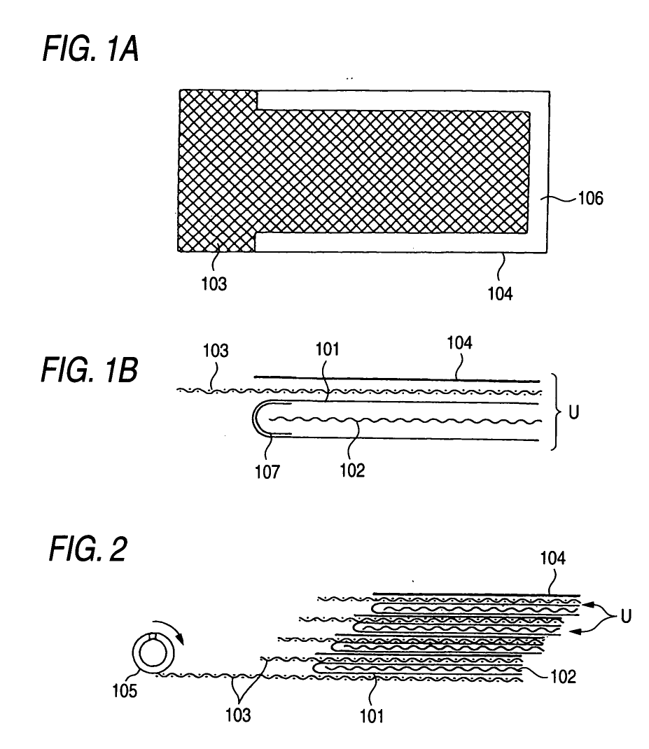

The present invention is described in detail below with reference to the accompanying drawings. FIGS. 1 to 3 are step views illustrating a method of manufacturing a spiral membrane element according to the present invention.

The spiral membrane element according to the present invention comprises a cylindrically wound body 304 comprising a perforated central tube 105 and, spirally wound therearound, a separation membrane 101, a feed-side passage material 102 and a permeation-side passage material 103 in a laminate state, and sealing portions 302 and 303 for preventing a feed-side fluid and a permeation-side fluid from being mixed together, as shown in FIGS. 1 to 3.

Each of the sealing portions 302 formed at both ends of the cylindrically wound body 304 is formed spirally by an adhesive with a substantially constant width, and has a trimmed section exposed on its whole end surface. The sealing portions 303 formed along the outermost edges of the cylindrically wound body 304 may also be formed by an adhesive, or by using a hot-melt adhesive, a heat-fusible adhesive tape, a heat-weldable sheet, etc., but for a simplified manufacturing process, it is preferable to form them by the same adhesive as the sealing portions 302.

The spiral membrane element of the present invention has a ratio of an ineffective membrane surface area to its whole membrane surface area of 0.02 to 0.10. The effective membrane surface area in the context of the present invention is the surface area of that portion of the separation membrane in the spiral membrane element which exhibits its separation performance, the ineffective membrane surface area is the surface area of that portion of the separation membrane which fails to exhibit any separation performance, and the whole membrane surface area is the surface area of the separation membrane obtained by totaling the effective and ineffective membrane surface areas.

If the ratio of the ineffective membrane surface area to the whole membrane surface area is less than 0.02, the sealing portions formed by applying an adhesive to the edges of the separation membrane have too small width to perform satisfactorily their function of preventing the feed-side fluid and permeation-side fluid from being mixed together. If, on the other hand, the ratio of the ineffective membrane surface area to the whole membrane surface area exceeds 0.10, the ineffective portions produce a greater pressure loss in the feed-side passage, thereby increasing pressure loss per unit effective membrane surface area of the spiral membrane element.

According to the present invention, the cylindrically wound body 304 has a ratio of its length to the length of the central tube 105 of 0.96 to 1.00. If the ratio is less than 0.96, the removal of a greater amount of separation membrane 101 by cutting brings about a decrease in the effective membrane surface area, resulting in increase in pressure loss per unit effective membrane surface area and also increase in the amount of materials cut off and disposed of as waste. This adversely affects the environment. If, on the other hand, the ratio exceeds 1.00, the central tube 105 has its ends embedded in the end surfaces of the spiral membrane element and makes it difficult to handle.

The cylindrically wound body 304 can be prepared in a suitable way by, for example, the manufacturing method shown in FIGS. 1 and 2. FIG. 1A is a top plane view of a separation membrane unit U, and FIG. 1B is a front view of the separation membrane unit U.

The method of manufacturing a spiral membrane element according to the present invention comprises the steps of spirally winding a separation membrane 101, a feed-side passage material 102 and a permeation-side passage material 103 in a laminate state around a perforated central tube 105 to form a cylindrically wound body 300, and forming sealing portions 302 and 303 for preventing a feed-side fluid and a permeation-side fluid from being mixed together, as shown in FIGS. 1 and 2.

A separation membrane unit U is first prepared by laying a separation membrane 101 folded in two halves with a feed-side passage material 102 sandwiched therebetween and a permeation-side passage material 103 on each other and applying adhesive layers 104 and 106 to the opposite longitudinal edges of the permeation-side passage material 103 and the edge at which its winding ends, for forming sealing portions 302 and 303 for preventing a feed-side fluid and a permeation-side fluid from being mixed together, as shown in FIG. 1.

FIG. 1B shows a protective tape 107 bonded to the folded portion of the separation membrane 101, although the protective tape 107 may not be used. The portions sealed with the adhesive layers 104 and 106 and that portion which the protective tape 107 prevents from exhibiting the function of the separation membrane 101 constitute the ineffective membrane surface area.

While the embodiment of the present invention has been described as laying the permeation-side passage material 103 on the separation membrane 101 folded in two halves with the feed-side passage material 102 sandwiched therebetween, and applying the adhesive layers 104 and 106 thereto, it is also possible to lay the separation membrane 101 folded in two halves on the permeation-side passage material 103 and apply the adhesive layers 104 and 106 thereto. It is also possible to use a continuous membrane folded in alternate directions instead of the separation membrane 101 folded in two halves, or position the separation membrane 101 so that its winding may end at its fold.

Reverse osmosis membrane, ultrafiltration membrane, microfiltration membrane, gas separation membrane, degassing membrane or the like can be used as the separation membrane 101. A net or like material can be used as the feed-side passage material 102. A net, knit or like material can be used as the permeation-side passage material 103.

Any known adhesive, such as a urethane, epoxy or hot-melt adhesive, can be used for the adhesive layers 104 and 106. According to the present invention, it is effective to use an adhesive in the form of a thixotropic fluid in order to facilitate the control of the width of the sealing portions 302 and 303 formed by the adhesive. A common adhesive of such type is prepared by adding a thixotropic substance to a liquid adhesive component, and examples thereof are unsaturated polyester and urethane adhesives, having fine particles of silica added thereto.

According to the present invention, the adhesive-coated portions of the separation membrane 101 have the pores of its porous layer closed to make it possible to suppress any flow parallel to it and thereby reduce the width of each sealing portion 302 or 303. The pores of its porous layer can be closed by, for example, filling the porous layer with an adhesive, crushing the porous layer under pressure, or melting it under heat.

One or more layers of separation membrane units U are laminated and wound spirally around the perforated central tube 105, and the adhesive layers 104 and 106 are cured by heating or the like to obtain the cylindrically wound body 300 sealed at least in the vicinity of the opposite ends of the permeation-side passage. This embodiment also seals the edge of the permeation-side passage at the terminal of its winding, and the periphery of the central tube 105.

The number of layers in which the separation membrane units U are laminated depends on the required quantity of the permeated fluid, and while at least one layer is sufficient, handling convenience sets an upper limit of about 50 layers. The larger the number of the laminated separation membrane units U, the smaller the number of turns in which each separation membrane unit U is wound will be.

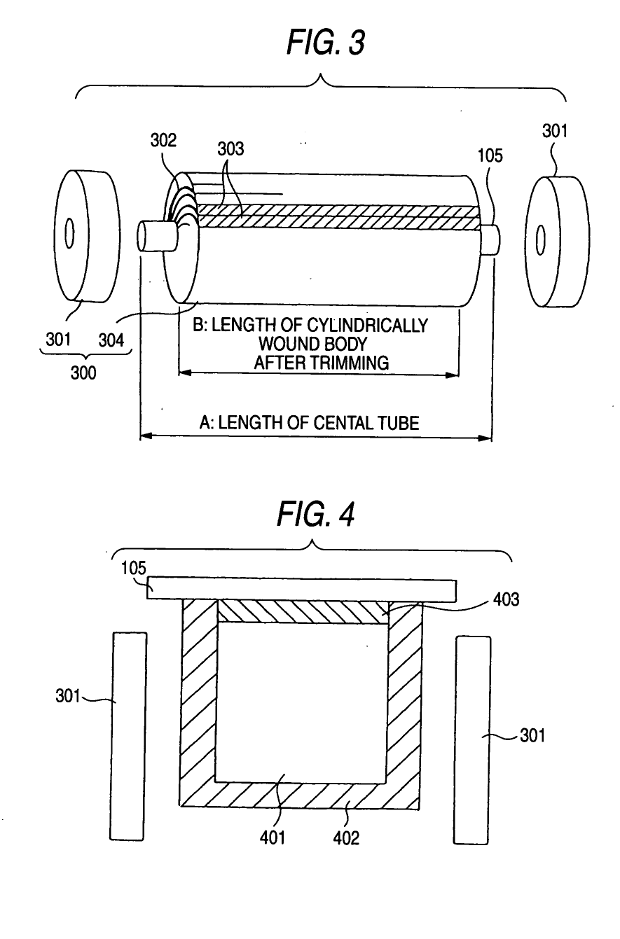

According to the present invention, the sealing portions 302 having a substantially constant width are formed by an adhesive in the vicinity of both ends of the cylindrically wound body 300 and a portion corresponding, in width, to from 20 to 60%, and preferably from 30 to 50%, of each sealing portion 302 is trimmed or removed by cutting, as shown in FIG. 3. As a result, there is formed a cylindrically wound body 304 having at both ends the sealing portions 302 each formed by an adhesive spirally with a substantially constant width and having a trimmed section exposed on its whole end surface. This embodiment represents an example in which trimmed portions 301 each having a constant width are removed from the cylindrically wound body 300 having an axial length substantially equal to that of the central tube 105. In FIG. 3, A is the length of the central tube and B is the length of the cylindrically wound body 304 after trimming.

Trimming may be performed by a method of cutting and removing each trimmed portion 301, while leaving the central tube 105 intact, such as a method in which a cutting apparatus having a rotary blade, etc., is used to cut the cylindrically wound body 300 along its whole circumference, while it is rotated relative to the cutting apparatus, or a method in which a fixed blade is used to cut the cylindrically wound body 300, while it is rotated.

FIG. 4 shows the cylindrically wound body after trimming in an exploded form. The surface area of an effective separation membrane portion 401 is the effective membrane surface area, the total surface area of resin-sealed portions 402 and a tape-bonded portion 403 is the ineffective membrane surface area, and the total surface area of the effective separation membrane portion 401, resin-sealed portions 402 and tape-bonded portion 403 is the whole membrane surface area.

The spiral membrane element of the present invention may further include an outer decoration material on the surface of the cylindrically wound body 304, if required. The outer decoration material may be formed by one or more sheets wound on the surface of the cylindrically wound body 304. Polyester, polypropylene, polyethylene, polyvinyl chloride, glass fiber cloth, etc., can be used as the outer decoration material.

The spiral membrane element of the present invention may further include perforated edge members for preventing its deformation (e.g. telescoping), a sealing material, a reinforcing material, etc., as required.

Other embodiments of the present invention are described below.

(1) Although the above embodiment describes an example of trimming both ends of the cylindrically wound body, the present invention does not preclude any cylindrically wound body trimmed only at one end. Further, the embodiment is shown in the drawing as the trimmed portions being of equal width at both ends, but it is also possible for the trimmed portions to be of different width between the right and left ends.

(2) Although the above embodiment is described as removing the trimmed portions having a certain width from the cylindrically wound body having an axial length substantially equal to that of the central tube, it is also possible to remove trimmed portions having a constant width, including sealing portions, after forming a cylindrically wound body having an axial length larger or smaller than that of the central tube.

(3) Although the above embodiment is described as removing the trimmed portions having a certain width, while leaving the central tube intact, it is also possible to cut the central tube with the trimmed portions and attach other members for extending the central tube.

The present invention is described in more detail by reference to the following examples, but it should be understood that the invention is not construed as being limited thereto.

### EXAMPLE 1

A spiral membrane element was fabricated in accordance with the manufacturing method of the present invention employing length of a central tube: 1,016 mm, length of a cylindrically wound body after trimming: 975 mm, width of an adhesive-sealed portion (adjacent to each trimmed portion): 15 mm, width of an adhesive-sealed portion (adjacent to the final end of a separation membrane): 25 mm, width of a protective tape: 25 mm, separation membrane: NTR-759HR (product of Nitto Denko Corporation), length of the separation membrane: 1,460 mm, width of the separation membrane: 1016 mm, the number of separation membrane units: 26, thickness of a feed-side passage material: 0.72 mm, and angle of intersections of a net of the feed-side passage material: 90°. An adhesive used was a thixotropic adhesive (UR-3501, product of H.B. Fuller Japan Co., Ltd.). Portions of the separation membrane to which the adhesive will be applied had the pores of their porous layers closed by melting under heat.

The spiral membrane element thus obtained was placed in a cylindrical stainless steel container having an inside diameter of 202 mm and a length of 1,280 mm, and examined for any pressure loss occurring to water supplied at a flow rate of 100 liters per minute at a temperature of 20° C. As a result, pressure loss per unit effective membrane area was 0.49 kPa/m².

### COMPARATIVE EXAMPLE 1

A spiral membrane element was fabricated in the same manner as in Example 1 and employing length of a central tube: 1,016 mm, length of a cylindrically wound body after trimming: 938 mm, width of an adhesive-sealed portion (adjacent to each trimmed portion): 34 mm, width of an adhesive-sealed portion (adjacent to the final end of a separation membrane): 50 mm, width of a protective tape: 50 mm, separation membrane: NTR-759HR (product of Nitto Denko Corporation), length of the separation membrane: 1,460 mm, width of the separation membrane: 1016 mm, the number of separation membrane units: 26, thickness of a feed-side passage material: 0.72 mm, and angle of intersections of a net of the feed-side passage material: 90°.

Using the element thus fabricated, pressure loss of the fluid separation membrane was measured under the same measurement conditions as in Example 1. As a result, pressure loss per unit effective membrane area was 0.54 kPa/m².

TABLE

| | | Comparative |
|---|---|---|
| | Example 1 | Example 1 |
| Ineffective membrane surface area/ | 0.08 | 0.17 |
| Whole membrane surface area | | |
| Length of cylindrically wound body | 0.96 | 0.92 |
| after trimming/Length of central tube | | |
| Pressure loss per unit effective | 0.49 | 0.54 |
| membrane area (kPa/m²) | | |
| Width of separation membrane removed | 41 | 78 |
| by trimming (mm) | | |

As is apparent from the results shown in the Table, the element according to Example 1 shows a pressure loss per unit effective membrane area which is about 10% smaller than that of Comparative Example 1. The number of separation membrane units used is the same between Example 1 and Comparative Example 1, and the amount of the raw materials used is unchanged. The width of the separation membrane removed by trimming is 41 mm which is nearly a half of 78 mm being the result of Comparative Example 1.

### COMPARATIVE EXAMPLE 2

A spiral membrane element was fabricated in the same manner as in Example 1, except that portions of the separation membrane to which the adhesive is applied do not have pores closed. The results obtained were the same as obtained in Example 1 as shown in the Table, but the result of a permeation-side pressure holding test indicated a lower sealing property of the sealing portions at both ends than that of Example 1.

### COMPARATIVE EXAMPLE 3

A spiral membrane element was fabricated in the same manner as in Example 1, except that the adhesive was applied along a width of 15 mm to the sealing portion at each end. The results obtained were the same as obtained in Example 1 as shown in the Table, but the result of a permeation-side pressure holding test indicated a lower sealing property of the sealing portions at both ends than that of Example 1.

It should further be apparent to those skilled in the art that various changes in form and detail of the invention as shown and described above may be made. It is intended that such changes be included within the spirit and scope of the claims appended hereto.

This application is based on Japanese Patent Application No. 2003-344303 filed Oct. 2, 2003, the disclosure of which is incorporated herein by reference in its entirety.

1. A spiral membrane element comprising a cylindrically wound body which comprises a perforated central tube and, spirally wound therearound, a separation membrane, a feed-side passage material and a permeation-side passage material in a laminated state, and a sealing portion for preventing a feed-side fluid and a permeation-side fluid from being mixed together, wherein the sealing portion formed at each of both ends of the cylindrically wound body is spirally formed with a substantially constant width by an adhesive and has a trimmed section formed on its whole end surface, and the cylindrically wound body has a ratio of its length to the length of the central tube of 0.96 to 1.00, and a ratio of an ineffective membrane surface area to the entire membrane surface area of 0.02 to 0.10.

2. The spiral membrane element as claimed in claim 1, wherein the adhesive comprises a thixotropic fluid.

3. The spiral membrane element as claimed in claim 1, wherein the separation membrane bonded adhesively on the sealing portions at both ends has the pores of its porous layer closed.

4. A method of manufacturing a spiral membrane element comprising the steps of spirally winding a separation membrane, a feed-side passage material and a permeation-side passage material in a laminate state around a perforated central tube to form a cylindrically wound body, and forming a sealing portion for preventing a feed-side fluid and a permeation-side fluid from being mixed together, wherein the sealing portion is formed with a substantially constant width by an adhesive in the vicinity of each of both ends of the cylindrically wound body and has 20 to 60% of its width cut off.
